(19) United States
(12) Patent Application Publication
(10) Pub. No.: US 2003/0110125 A1
(43) Pub. Date: Jun. 12, 2003

(54) American dream coalition computer system

(76) Inventor: Philip Carragher, Glencoe, IL (US)

Correspondence Address: PETER K. TRZYNA, ESQ., P O BOX 7131, CHICAGO, IL, 60680, US

(21) Appl. No.: 10/316,910

(22) Filed: Dec. 11, 2002

Related U.S. Application Data
(60) Provisional application No. 60/339,658, filed on Dec. 12, 2001.

(51) Int. Cl. G06F 17/60

(52) U.S. Cl. 705/38

(57) ABSTRACT

A method for managing finances and risks with a computer, the method including the steps of: collecting credit, job, health, family, and financial information at the computer; evaluating this information with the computer; scoring this information with the computer; and generating output including information on financial and risk management.

This is a continuation-in-part of U.S. patent application Ser. No. 60/339,658 filed by the same inventor on Dec. 12, 2001, incorporated by reference.

### I. TECHNICAL FIELD OF THE INVENTION

The present invention pertains to an electrical digital computer machine and a data processing system, methods of making and for using the machine, products produced thereby, as well as data structures and articles of manufacture pertaining thereto, and all necessary intermediates of that which is disclosed herein, all in the field of computerized aspects of data accumulation, evaluation, reporting, and dispersing for the purposes of risk management, investment, and project management.

### II BACKGROUND OF THE INVENTION

The American Dream Coalition is defined as a grouping of different entities, public and private, that contribute in various ways to reduce risks and costs, educate and empower individuals, groups, commercial, and government entities for real estate, banking, finance, insurance, health, and educational needs (hereinafter referred to as “needs”). Contributions can be a service, product, or in payment form. Credits can flow to any coalition member for any needs. The calculations of credits and the database of credits and the flow of funds and credits and the management of project(s), and accumulation database, and disbursement are maintained by using a digital network to handle data on this.

Incented to participate for public or private gains, coalition members and non-members from government, commercial, group, and individual sectors contribute in various fashions and amounts to help coalition members and non-members pay for and reduce risks and needs' costs and to gain credits and recognition for having contributed in financial and non-financial ways, all carried out by computer tracking.

In the United States and abroad, of The American Dream of homeownership, wealth accumulation, protection of assets, and improved health and education for all can be catalyzed by coalitions that create, for the benefit of coalition members, non-members and societies, a means by which the products and services they utilize and deliver would reward them and further promote the American Dream. These databases of information are maintained in a digital environment, and communications and solicitations and dispersements occur over and due to the network. As an example of different methods that can be utilized to promote a specific part of the American Dream, that of homeownership (Homeownership Coalition):

1) Consumers are incented to buy homes from coalition members and finance those homes through programs available through the coalition computer system. For instance, a special credit card rewards usage with credits for a down payment, closing costs, buy-downs, escrows, etc. Builders and real estate professionals, material suppliers, and mortgage originators, servicers, and investors all contribute with credits, services, special financing, etc. to help consumers purchase homes. The credits coming from all points of sale are communicated to a database via an electronic network. Solicitations flow through an electronic network and unique mediums. Special financing programs are contacted and utilized via this electronic network that supports these tasks, performs computerized assessments, and sends digitized advice.

2) Renters are incented and educated to become a home owner and more financially savvy with a credit/debit/membership card and an account aggregation system that employs direct deposit and bill pay and bill presentation. The offer of a credit/debit card can be generated through an electronic medium as the potential renter is assessed by a digital underwriting system. Lenders, builders, real estate professionals, affordable housing agencies, Fannie Mae and Freddie Mac, and other coalition members and non-members could issue pro-active offers to help someone buy a home and related items and services. Offers are communicated electronically and through unique mediums. Loan terms could improve instantaneously as credit scores improve, risks lessen, and portfolio insurance costs drop and portfolio and security ratings rise. This dynamic pricing/term change is calculated and communicated using electronic databases, computers, and this electronic network. An alert to the entity can be instigated and communicated using an electronic network or using a cell phone or other portable device.

3) Servicers can retain loans by offering special terms to coalition members that would keep their loans from paying off. A consumer can buy an item financed at favorable rates through a credit instrument with terms subsidized by the product or service provider. As well, Lenders can gain additional security on the loan by having it paid through mortgage escrows, and pre-payment penalties can be agreed upon as consideration for more favorable terms. The offers can be communicated through the digital network; the change in the loan payments are computed electronically and communicated digitally.

4) Companies and governments use a commercial/government credit card for purchases and buy goods and services from other coalition members that give rewards. Other aspects of the working environment can yield credits as well such as: attendance, timeliness, health, safety, and welfare issues, low average expense accounts; all these factors could into the pool of credits that is used to help buy homes for employees or others, get better rates and terms on banking, insurance, health, and educational products and services, and pass regulatory requirements and gain good will. The same is true for quasi-governmental agencies and for-profit and not-for-profit groups. These databases are maintained in a digital environment and communications occur over the digital network with calculations performed by a computer.

5) Tax incentives flow to offset the costs of needs. This system calculates and communicates through this computer network.

6) Systems are structured to carry out the objective of utilizing, modifying, and creating ways to inform and educate populations about the American Dream and empower them to achieve it with computer support. Faith-based institutions can also be extremely helpful resources both in the United States and abroad for linking into this system.

7) Coordination and synergies with other public and private sectors is also helpful; long term care considerations are built into programs that provide for an aging population's health and housing needs, including coordination of entities involved in long term care costs, care, insurance, and reverse mortgages, with computer support.

The specific aim of homeownership plays an important role in the attainment of the American Dream because of its ability to build wealth and provide housing. Underlying that aim is the basic human right to decent housing. The coalition is utilized to promote decent housing for all, as well as promote literacy and education, clean governments, accountability, open economies, and freedom, using coordinated computer support.

The coalition has sub-coalitions that have specific aims: the housing coalition, the insurance coalition, the education coalition, the freedom coalition, the free press coalition, the open economy coalition, the government coalition, etc. All carry the intent of the American Dream Coalition, and the specific details of each coalition's methods, much like what was outlined above for the Homeownership Coalition.

Populations, such as immigrants and minorities, tend to miss participation in all or some aspects of the American Dream because of informational and resource shortfalls. For instance, many consumers believe that they need to have accumulated a 20% down payment in order to buy a home, not knowing of the proliferation of low down payment or no down payment mortgages. Also, they may not know of that availability of reasonably priced homes in the suburbs. Overcoming these informational shortfalls can mean the difference for some families between participation in the American Dream of homeownership or not.

### III. SUMMARY

In view of the foregoing, an object of the invention is to improve over or overcoming some or all of the drawbacks indicated herein, as observed by the inventor. By way of perspective, this can involve a computer system linked to pertinent data and information to provide more timely and comprehensive information on entity's credit and financial information. The computer system can evaluate the data and information of individual entities and the financial web, and can implement scoring models that help as an evaluation tool. The computer system can share data and information for research purposes, as well as carry out the scoring models with thresholds that incent specific behaviors. The computer system can also create transparencies that help protect against liquidity crises and market meltdowns.

The computer system can be useful for educating consumers and helping them become more financially savvy, as well as in producing more efficient consumer and business products.

More particularly, the present invention can be carried out by providing an improved digital electrical computer-based system configured to address the foregoing objects, including a machine (programmed computer), methods for making and using it, products produced by the method, data structures, and necessary intermediates, collectively referenced herein after as the method (for the sake of brevity). The invention can also be viewed as exemplified as a computer-aided method.

### IV. BRIEF DESCRIPTION OF THE DRAWING

FIG. 1 is a flow chart in accordance with the present invention.

FIG. 2 is comprised of FIG. 2A and FIG. 2B, collectively, and is a flow chart in accordance with the present invention.

FIG. 3 is comprised of FIG. 3A and FIG. 3B, collectively and is a flow chart in accordance with the present invention.

FIG. 4 is a flow chart in accordance with the present invention.

### V. DETAILED DISCUSSION OF THE PREFERRED EMBODIMENT

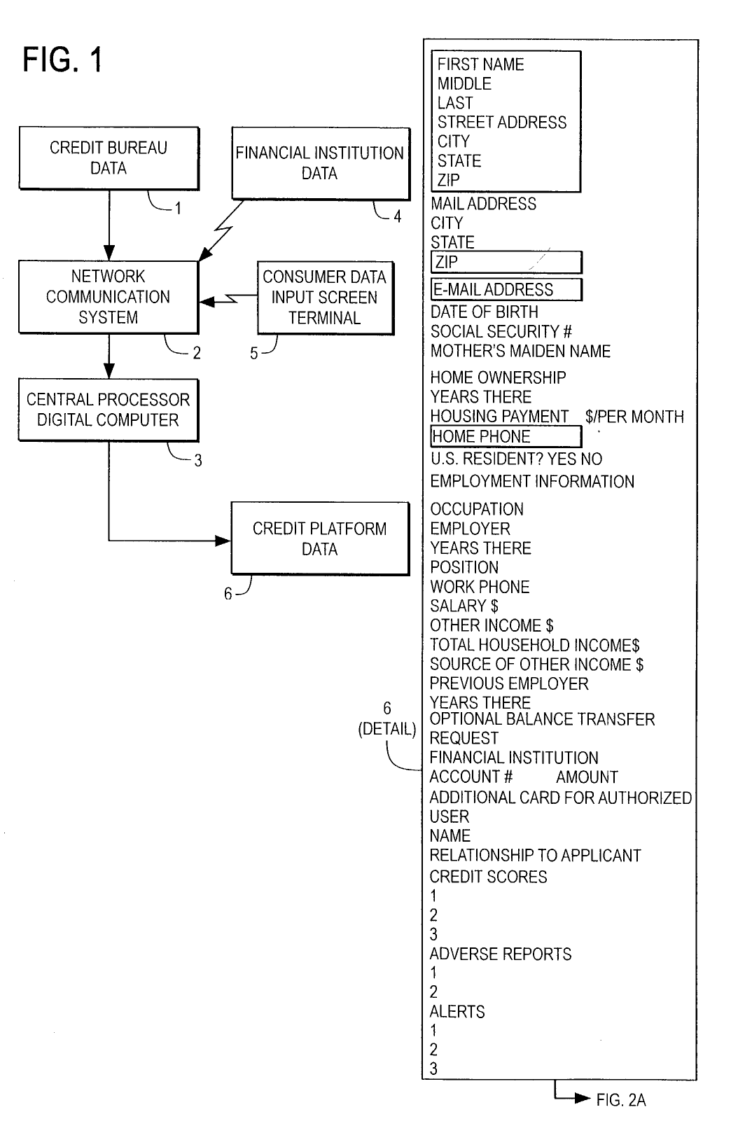

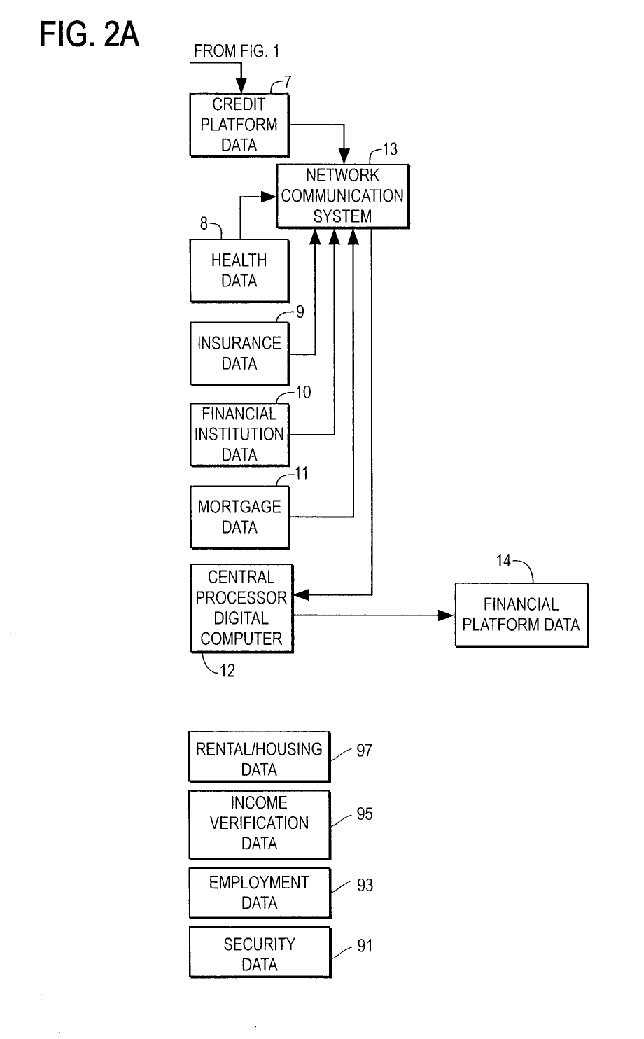

FIG. 1 shows, in block diagram form, the computer-based elements, which can be utilized to implement the present invention. FIG. 1 provides the foundation for the invention. There are several components to the invention, in the present embodiment, though it is to be understood that this is an illustrative teaching, with all elements, steps, and features being replaceable, substitutable, and interchangeable within the spirit of the invention that transcends a particular embodiment

Accordingly, Credit bureau data (1) represents third party data sent via Electronic File Transfer (EFT) and a TCP/IP network communications system (2). Credit bureau information from Equifax, Experian, and others.

With regard to Network Communications Systems (2), any upstream, internet Service Provider (ISP) utilizing TCP/IP to transmit data between Data Input Screens. Examples of ISPs include uunet, starnetusa, and Exodus. Well-known and accepted protocols may be any transmission standard able to conduct digital information, including optical, FireWire, fiber optic, infrared, cellular, wireless, hard wire, SCSI, ethernet, trunk lines, satellite, and other like systems, may be employed.

Central Processor and Digital Computer (3) (or via distributed computing) represents the electrical computing devices that receive, process, store, analyze, and distribute data. It is to be expected that numerous computing devices will be employed as business volume grows. The Central Processor and Digital Computer (3) can be comprised of these components:

one or more CPUs (Central Processing Units);

one or more digital computers commonly referred to as “servers” (“servers” are the gateway between Local Area and Wide Area digital computers);

Data storage (hard drives)

Routers;

Applications, such as web browsers, word processors, database engines, etc.

Financial Institution Data represents third party data sent via Electronic File Transfer (EFT) and a TCP/IP network communications system (2). Data from banks such as Bank One and many others.

Further there is Data Input Screen and Terminal (5). Using a network-enabled computer, such as a PowerPC604e and Apple Cinema display, the consumer links to the invention network site by telephone, or telephone-adaptive device, such as TDD. Using his or her touch-tone phone or TDD, the customer interacts with Customer Service Center.

Credit platform data (6) illustrates the central storage system for all individual consumer credit data.

Health data (8) represents the central storage system for all individual consumer health data.

Centralized databases exist for access by insurance companies for underwriting purposes. For example, Insurance Data (9) represents the central storage system for all individual consumer insurance data like C.L.U.E.

Mortgage Data (10) represents the central storage system for all consumer mortgages. Fannie Mae, Freddie Mac, and title insurance companies have that information.

Financial Platform Data (14) illustrates the central storage system for individual consumers' financial data.

Business Product Data (17) represents the business products and services being offered to the consumers such as account aggregation, cell phones, insurance products, etc.

Subscriber database (18) represents the central storage system of all individual financial platform data.

Turning now to FIG. 1, note that Credit bureau data (1) is sent through the Network Communications System (2) to the Central Processor Digital Computer (3) along with information from financial institution databases (4) and imput from the consumer (5). The computer analyzes and compiles the credit platform data and displays it (6).

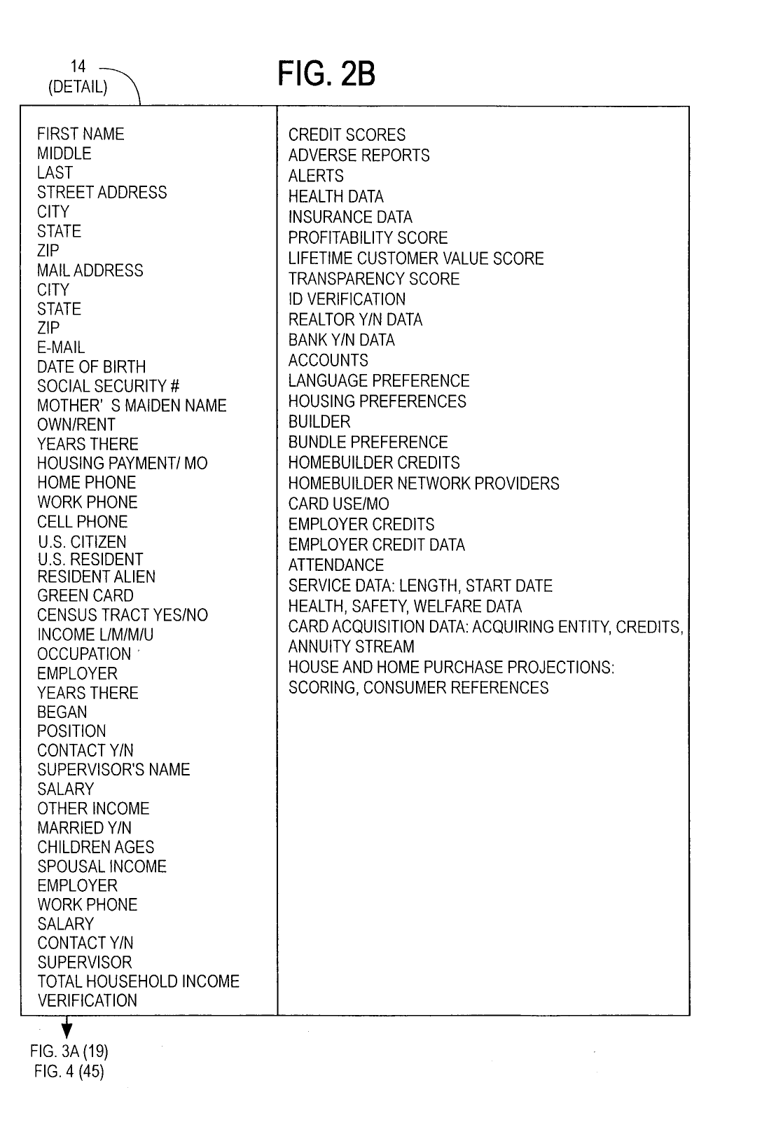

Now in FIG. 2, Credit platform data (7) is sent to the Network Communications System (13) along with Health data (8), insurance data (9), financial institution data (10), checking account data (99), rental/housing data (97), income verification data (95), employment data (93), security data (91), and mortgage data (11). This data is received, analyzed, and processed by the Central Processor Digital Computer (12) and displayed as Financial Platform Data (14){{substitute new detail for (14)}}.

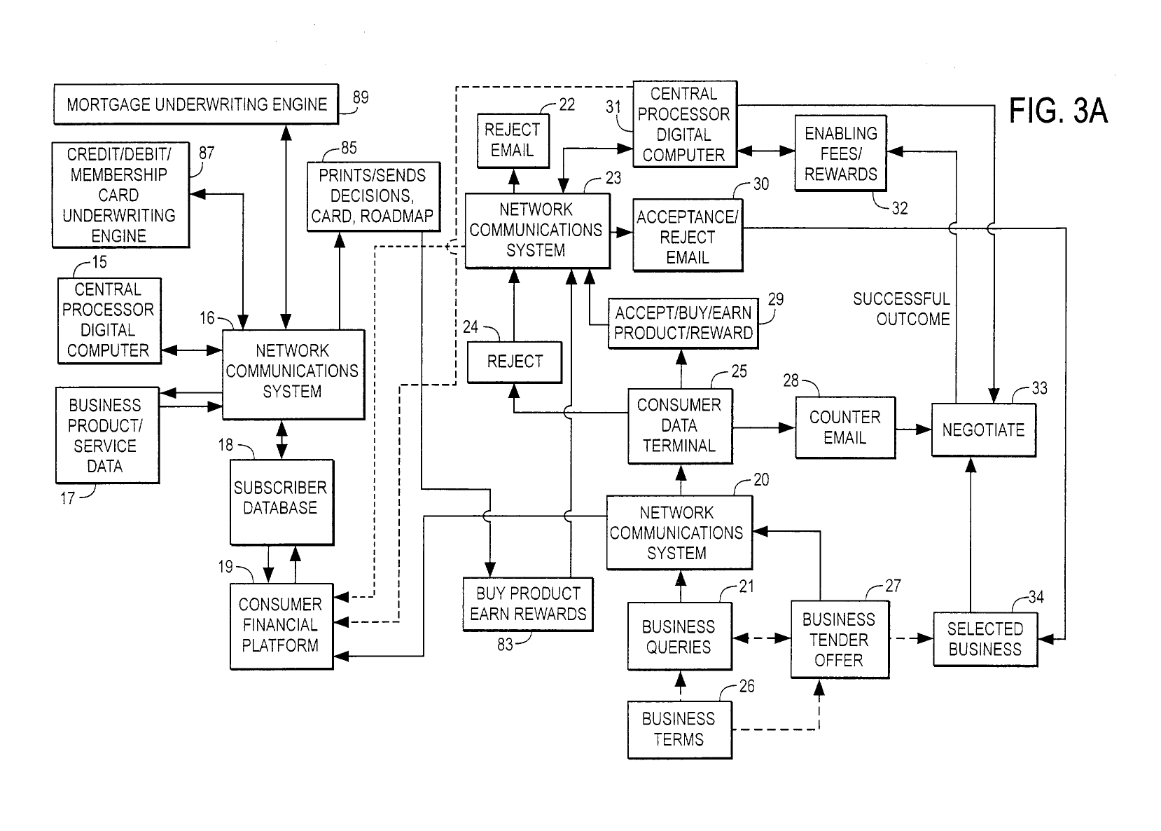

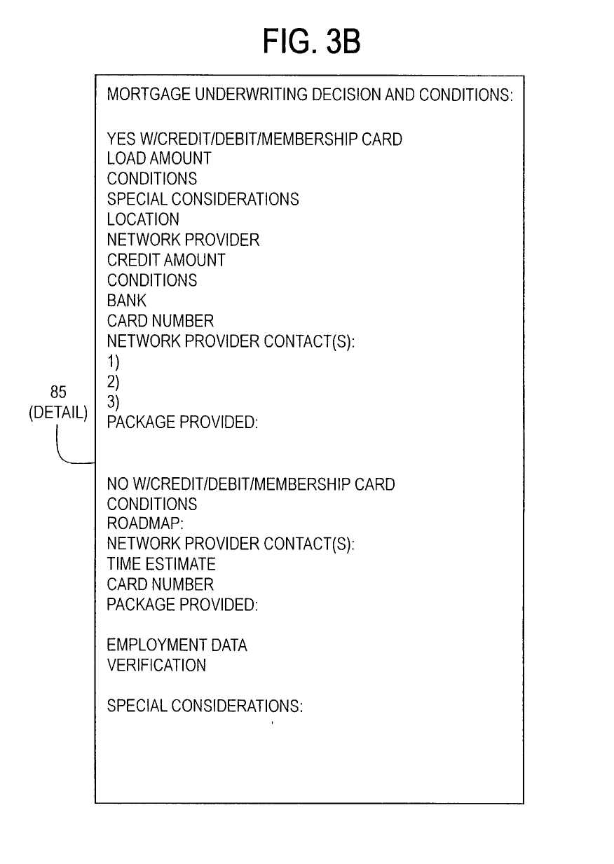

Referring to FIG. 3, Businesses tender offers (27) after making queries (21) through the Network Communications System (20) to Subscriber Database (18) which sends pertinent data through the Central Processor Digital Computer (15) that sorts the queries into individual offers. These are sent through the Network (16) as business product/service data (17) that is specified into business terms (26) to create individual offers (27). The consumer (25) may reject (24), accept/buy/earn product/rewards (29), or counter (28) the offer. The rejection and acceptance travel through the Network (23), and either a reject email (22) or an acceptance/report email (30) is sent. An acceptance email travels to both the selected business (34) and the Central Processor (31), the latter charging any enabling fees/rewards (32). If the offer is countered (28), the selected businesses (34) may negotiate (33). A successful negotiation results in enabling fees being charged (32) and rewards reported to the database. These offers coincide with information garnered from running the financial information through a Mortgage Underwriting Engine (89) and a Credit/debit/membership Card Underwriting Engine (87). Then the consumer receives a printed decision, card, and roadmap (85). This drives the consumer to utilize the network providers and earn rewards (83).

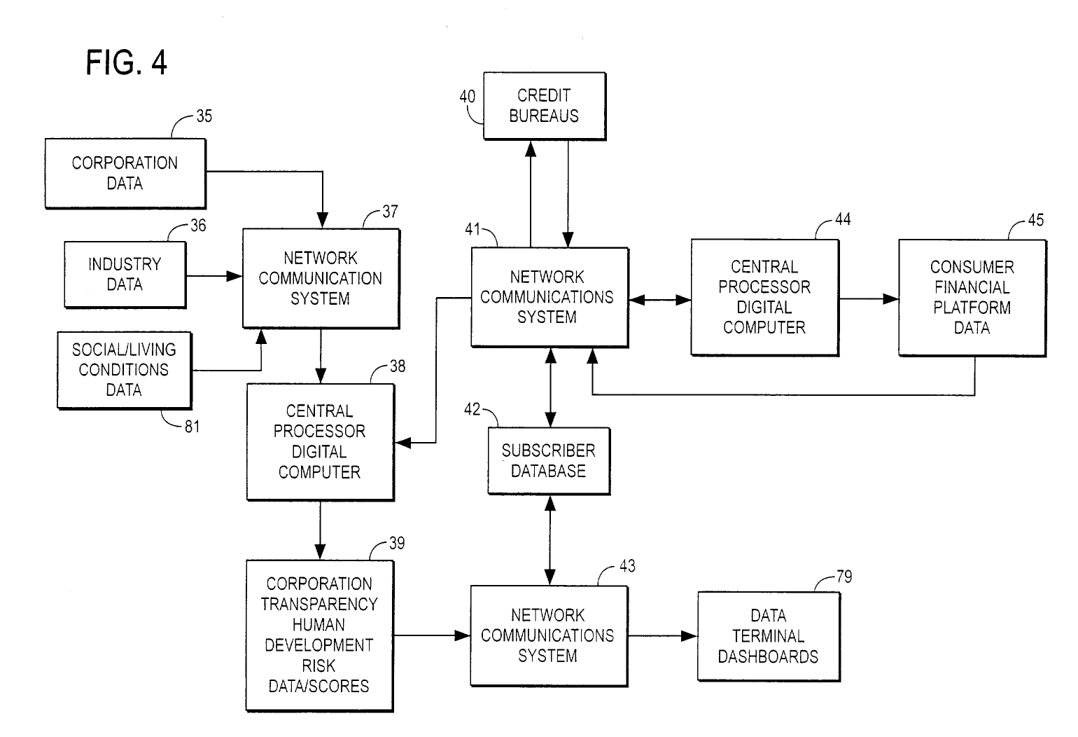

As illustrated in FIG. 4, Corporation (35), Social, Living Conditions, and Industry (36) Data are sent through Network (37) to Central Processor (38) where it is compiled, analyzed, and evaluated and creates Corporation Transparency Risk Data (39) and scores and Human Development Risk Data and scores. This data is sent through the network (43) to the subscriber database (42) of consumer financial platforms, which sends, through the network (41), this combined data to the credit bureaus (40) and Central Processor (44). The Central Processor compiles, analyzes, evaluates, and scores the data and sends this to the Consumer Financial Platform Data (45). The credit bureaus recompute the credit scores and send to the Central Processor (44) via the network (41). Dashboards detailing the scores and risk data are sent to data terminals for examination (79).

The updated consumer platform data is sent to the subscriber database. By carrying out the foregoing, there is illustrated an apparatus and method for managing finances and risks with a computer. The computer carries out the method, which can include the steps of: collecting credit, job, health, family, and financial information at the computer; evaluating this information with the computer; scoring this information with the computer; and generating output including information on financial and risk management.

While this invention has been particularly shown and described with reference to a preferred embodiment, it will be readily appreciated by those of ordinary skill in the art that various changes and modifications may be made without departing from the spirit or scope of the invention. It is, therefore, contemplated that the appended claim(s) be interpreted as including the foregoing and other changes and modifications.

I claim:

1. A method for managing finances and risks with a computer, the method including the steps of:
collecting credit, job, health, family, and financial information at the computer;
evaluating this information with the computer;
scoring this information with the computer; and
generating output including information on financial and risk management.
